(19) United States
(12) Patent Application Publication
(10) Pub. No.: US 2012/0315964 A1
(43) Pub. Date: Dec. 13, 2012

(54) AIR DIVERTER FOR COMBINE SHOE

(75) Inventor: Joseph M Biggerstaff, Wichita, KS (US)

(73) Assignee: AGCO CORPORATION, Duluth, GA (US)

(21) Appl. No.: 13/493,014

(22) Filed: Jun. 11, 2012

Related U.S. Application Data
(60) Provisional application No. 61/495,448, filed on Jun. 10, 2011.

(51) Int. Cl. A01F 12/48

(52) U.S. Cl. 460/99

(57) ABSTRACT

A cleaning system in a combine harvester includes a fan producing an airstream, an oscillating upper chaffer that separates grain and smaller residue from larger non-grain particles while the airstream entrains light non-grain particles and carries them out the rear of the machine. An oscillating lower sieve receives the grain and smaller residue passing through the upper chaffer and allows grain to pass through openings while residue unable to penetrate the lower sieve travels off the end of the lower sieve and the airstream entrains light non-grain particles and carries them out of the machine. An airstream diverter located between the upper chaffer and the lower sieve redirects a portion of the airstream through lower air-flow areas of the upper chaffer. The diverter is horn-shaped with a narrow leading edge and a wider trailing edge with a concave air-directing surface between the leading and trailing edges.

### CROSS REFERENCE TO RELATED APPLICATIONS

This application claims priority to U.S. Provisional Application No. 61/495,448 filed Jun. 10, 2011, entitled “AIR DIVERTER FOR COMBINE SHOE”.

### BACKGROUND OF THE INVENTION

1. Field of Invention

This invention relates to cleaning systems for combine harvesters, and more particularly, to a mechanism for managing the airflow through the cleaning system of a combine harvester.

2. Description of Related Art

Combine harvesters are provided with cleaning systems used to remove chaff and other residue from the threshed grain. Within the cleaning system, oscillating sieve assemblies in conjunction with air flow remove the chaff from the threshed grain, which gravitates through the chaffer and sieve assembly to an oscillating clean grain pan. The clean grain pan, in turn, directs the clean grain to a discharge auger that elevates the grain to an onboard storage bin. A second oscillating pan directs materials other than grain over the edge of the bottom sieve assembly to a different discharge outlet for recirculation back through the threshing, separating and cleaning apparatus to extract the previously unthreshed grain.

A fan produces an airstream through the chaffer and sieve assembly that entrains the lighter non-grain particles and carries them out the rear of the harvester. However, some areas in the cleaning system may not have positive air flow. Such areas of low air flow can lead to trash getting into the clean grain pan and storage bin.

### OVERVIEW OF THE INVENTION

In one embodiment, the invention is directed a cleaning system for use in a combine harvester for removing chaff from threshed grain. The cleaning system includes a fan producing an airstream. The cleaning system also includes an oscillating upper chaffer that allows grain and smaller residue to pass downwardly through openings therein while larger non-grain particles are directed away from the upper chaffer while the airstream from the fan entrains light non-grain particles and carries them out the rear of the machine. An oscillating lower sieve receives the grain and smaller residue that has passed through the upper chaffer and allows grain to pass downwardly through its openings while residue unable to penetrate the lower sieve travels off the end of lower sieve and the airstream from fan entrains light non-grain particles and carries them out the rear of the machine. The cleaning system includes an airstream diverter located between the upper chaffer and the lower sieve redirecting a portion of the airstream through lower air flow areas of the cleaning system. In one embodiment, the diverter has a horn shape with a narrow leading edge and a wider trailing edge with a concave air directing surface between the leading edge and trailing edge.

These and other features and advantages of this invention are described in, or are apparent from, the following detailed description of various exemplary embodiments of the systems and methods according to this invention.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 is a schematic side elevational view of a combine harvester with parts broken away to reveal internal details of the feeding, threshing, separating and cleaning portions of the machine;

FIG. 2 is an enlarged perspective view of a portion of the cleaning apparatus of the harvester of FIG. 1;

FIG. 3 is a plan view of the cleaning apparatus of the harvester of FIG. 1; and

FIG. 4 is a side view of a portion of the cleaning apparatus of FIG. 2;

FIG. 5 is a perspective view of the air diverter of the cleaning apparatus of FIG. 2; and

FIG. 6 is a cross sectional view of the diverter taken along line 5-5 of FIG. 5.

Corresponding reference characters indicate corresponding parts throughout the views of the drawings.

### DESCRIPTION OF EXAMPLE EMBODIMENTS

The present invention is susceptible of embodiment in many different forms. While the drawings illustrate and the specification describes certain preferred embodiments of the invention, it is to be understood that such disclosure is by way of example only. There is no intent to limit the principles of the present invention to the particular disclosed embodiments. References hereinafter made to certain directions, such as, for example, “front”, “rear”, “left” and “right”, are made as viewed from the side of the combine.

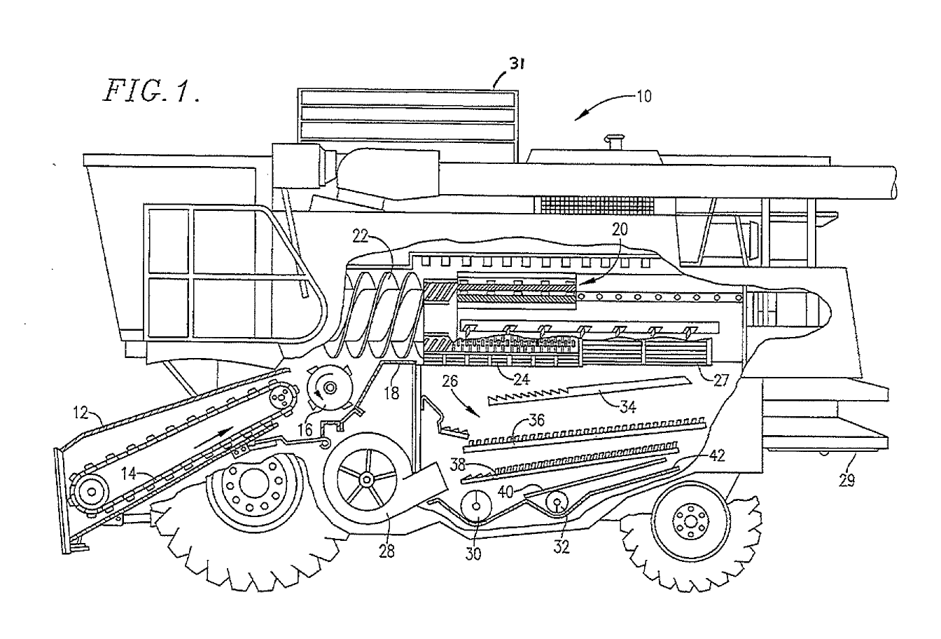

FIG. 1 schematically illustrates one type of combine harvester 10 to which the present invention relates. Although the harvester 10 chosen for purposes of illustration is a so-called axial rotary combine in which the threshing and separating mechanism comprises a rotor disposed axially of the machine with respect to its fore-and-aft axis, many other types of threshing and separating mechanisms are currently in commercial use and it is not intended that the principles of the present invention be limited to any one particular type of threshing and separating mechanism.

In relevant part, harvester 10 has a feed housing 12 that receives harvested materials from a suitable header (not shown) and advances such materials upwardly and rearwardly via a conveyor 14 toward a beater 16 rotating in a counterclockwise direction viewing FIG. 1. Beater 16 impels the harvested materials upwardly and rearwardly into a receiving housing 18. Housing 18 contains the front end of a threshing and separating rotor broadly denoted by the numeral 20, such front end having a series of helical vanes 22 that start the materials moving rearwardly in a spiral path of travel along the outside of the rotor. As the materials move rearwardly, concaves 24 cooperate with rotor 20 to thresh the materials, and initial separation occurs as grain and smaller residue are pushed through the grated concaves region by centrifugal force to the cleaning apparatus 26. Large residue pieces such as stalks and stems continue to move rearwardly past a separating grate 27 which allows grain to pass radially out of the rotor area to cleaning apparatus 26, but not the larger residue. Such residue eventually discharges out the rear end of the rotor assembly where it is acted upon by a chopper or spreader 29 and deposited on the ground.

Generally speaking, the threshed grain works its way downwardly through the machine as it is acted upon cleaning apparatus 26. During this process, light chaff particles become airborne by a rearwardly directed airstream generated by a fan 28 of cleaning apparatus 26 and are discharged out the rear of the machine. Clean grain ultimately finds its way to a discharge auger 30 leading to an elevator that conveys the clean grain up to a storage tank 31 at the top of the machine. Tailings, consisting of some grain along with other particles of residue, find their way to a tailings return auger 32 which then elevates the tailings via means not illustrated for recirculation back through the threshing, separating and cleaning areas to further separate grain from such residue.

The combine harvester 10 includes as part of its cleaning apparatus 26 an upper oscillating pan 34 that delivers materials received from concaves 24 and grate 27 generally downwardly and forwardly. Those materials from pan 34 land on an upper oscillating upper chaffer 36. The upper chaffer 36 allows grain to pass downwardly through openings in the upper chaffer 36 while larger particles are impelled generally upwardly and rearwardly until being discharged off the rear end of the upper chaffer 36 and out the back of the combine harvester 10 to the ground. A finer oscillating lower sieve 38 receives the grain and residue that has passed through the upper chaffer 36 and performs essentially the same type of classifying function as upper chaffer 36. The smaller kernels of grain fall through the lower sieve 38 and onto an oscillating grain pan 40, which delivers the grain into the clean grain auger 30. The larger tailings particles unable to penetrate lower sieve 38 travel off the rear discharge end of lower sieve 38 and drop to a tailings return pan 42 that feeds such materials to the tailings return auger 32. As the kernels of grain gravitate through upper and lower sieves 36 and 38, the airstream from fan 28 entrains the light non-grain particles and carries them out the rear of the machine.

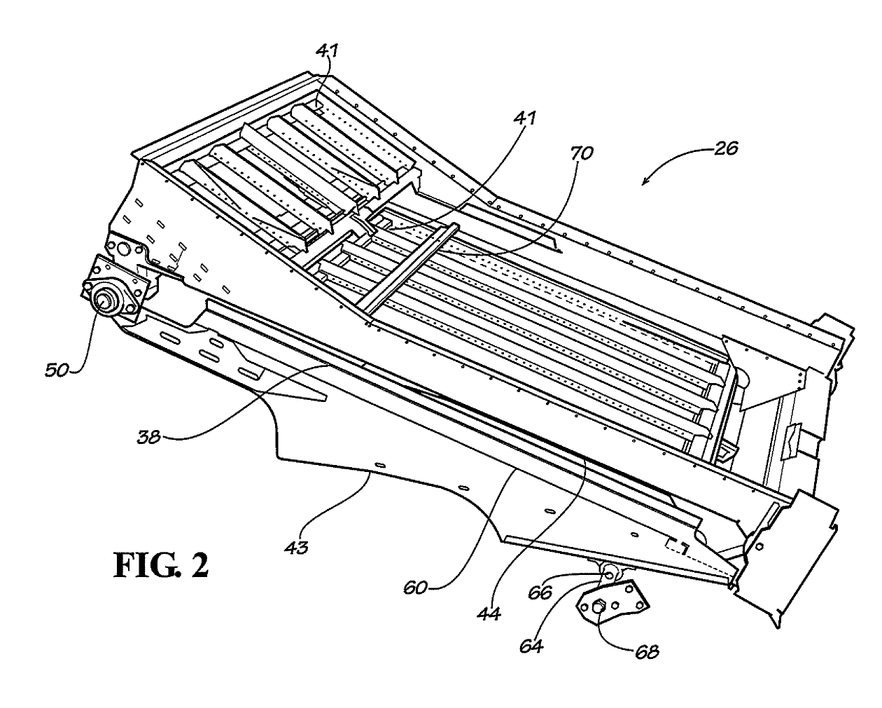

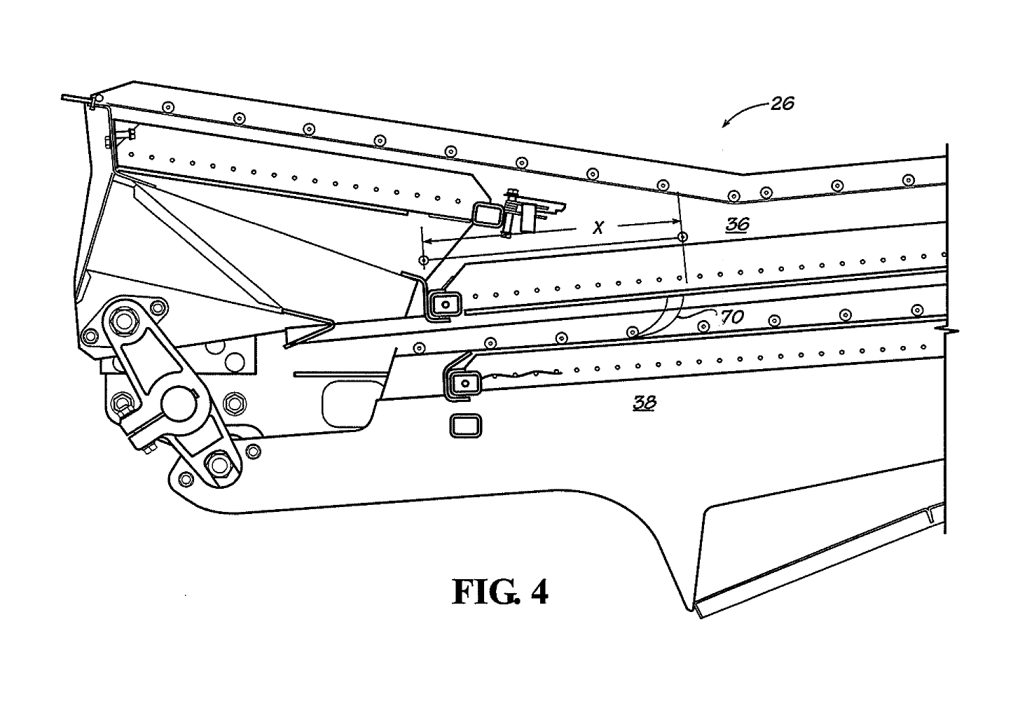

FIG. 2 is a somewhat enlarged, fragmentary view of one embodiment of the cleaning apparatus 26 with the upper chaffer 36 and a majority of separating grates 41 of and the lower sieve 38 removed for clarity. The upper chaffer 36 (best seen in FIG. 4) and lower sieve are supported by a frame 43. In the illustrated embodiment, upper chaffer 36 is supported on an upper portion 44 of frame 43. The upper portion 44 is connected to a transverse, oscillating jackshaft 50 using any suitable means as is known in the art. In one embodiment, the lower sieve 38 is desirably mounted on a common lower portion 60 of frame 42 it shares with the clean grain pan 40 and tailings return pan 42 (FIG. 1). At its front end, the lower portion 60 is suspended from oscillating shaft 50 via a suitable pivot connection as is known in the art. At its rear end, lower portion 60 is supported by a link 64 that has a pivotal connection 66 with the lower portion 60 and a pivotal mounting 68 with the structural frame of the harvester 10. Driving power for oscillating the upper and lower portions 44, 60 of the frame 43 is provided by a suitable eccentric input drive unit connected to the jackshaft 50 so as to cause oscillating rotation of the shaft.

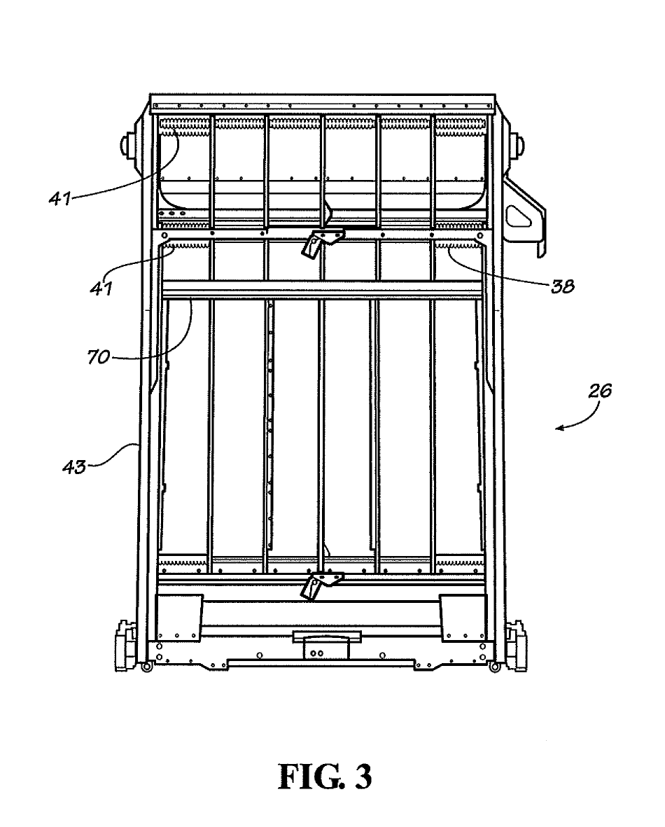

According to the invention, the cleaning apparatus 26 has an air diverter 70 to direct air flow to lower air flow areas or dead spots in the cleaning apparatus 26. In the illustrated embodiment, the diverter 70 is located between the upper chaffer 36 and the lower sieve 38 and directs higher velocity air flowing in an area between the chaffer 36 and sieve 38 up through the chaffer 36. As best seen in FIG. 3, the diverter 70 extends in a transverse direction between sides 72 of frame 43. The length of the diverter 70 is desirably substantially equal to the distance between opposing sides 72 of the frame 43. The diverter 70 may have a lip (not shown) on each end that is used to bolt or otherwise fasten the diverter 70 to the sides 72 of the frame 43 using sound engineering judgment. The diverter 70 may be attached to the chaffer 36 such that it oscillates with the chaffer 36 or may be attached to the sieve 38 such that it oscillates with the sieve 38. In the illustrated embodiment, the diverter 70 is attached to the underside of the chaffer 36.

The diverter 70 desirably has a height H of between about 20 and 75 mm and a width W of between about 50 and 100 mm. The height H of the diverter 70 is desirably based upon the space between the chaffer 36 and sieve 38, leaving room for suitable tolerance requirements. In one embodiment, the distance between the chaffer 36 and sieve 38 varies as the two components oscillate back and forth with respect to each other. For example, in one embodiment, at the furthest point, the height distance from chaffer 36 to sieve 38 is about 85 mm, and at the closest point, the chaffer 36 and sieve 38 are about 58 mm apart. The diverter 70 is sized and positioned such that there is a clearance of at least about 15 mm between the diverter 70 and the adjacent moving chaffer 36 or sieve 38 at the closest point.

In the illustrated embodiment, the diverter 70 is located near the front end of the chaffer 36. The diverter is desirably located a distance X from the front of the chaffer 36 as best seen in FIG. 4 that is between 10% and 30% of the length of the chaffer 36 as measured from the front of the chaffer 36. In one example embodiment, the chaffer 36 had a total length of 2003 mm, and the diverter was positioned 360 mm from the front of the chaffer 36.

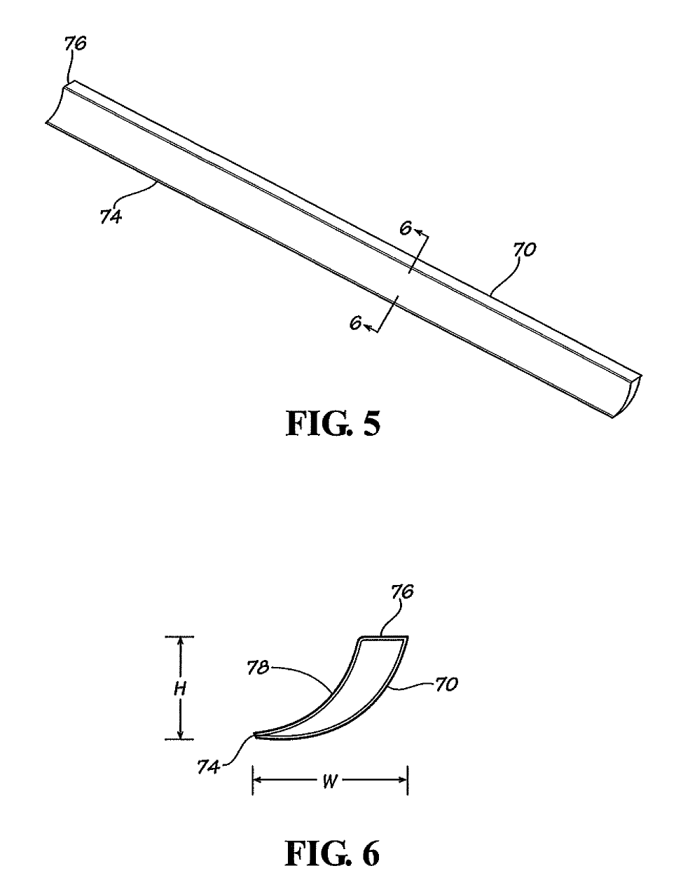

Turning now to FIGS. 5 and 6, the diverter 70 desirably has a horn shape with a narrow leading edge 74 and a wider trailing edge 76 with a concave air directing surface 78 between the leading edge 74 and trailing edge 76. It is believed that this horn shape reduces the formation of dead spots behind the diverter 70, thereby permitting more distributed air flow. In one embodiment, the diverter 70 is formed of extruded aluminum. However, other materials and methods may be used to form the diverter 70 without departing from the scope of the invention.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings, in addition to the scope of the invention defined by the claims.

What is claimed is:

1. A cleaning system for use in a combine harvester for removing chaff from threshed grain, the cleaning system comprising:
a fan producing an airstream;
an oscillating upper chaffer that allows grain and smaller residue to pass downwardly through openings therein while larger non-grain particles are directed away from the upper chaffer while the airstream from the fan entrains light non-grain particles and carries them out the rear of the machine;
an oscillating lower sieve that receives the grain and smaller residue that has passed through the upper chaffer that allows grain to pass downwardly through openings therein while residue unable to penetrate the lower sieve travel off the end of lower sieve and the airstream from fan entrains light non-grain particles and carries them out the rear of the machine; and
an airstream diverter located between the upper chaffer and the lower sieve redirecting a portion of the airstream through the upper chaffer.

2. The cleaning system of claim 1 wherein the air diverter redirects the portion of the airstream to lower air flow areas of the cleaning system.

3. The cleaning system of claim 1 wherein the upper chaffer and lower sieve are supported by a frame, wherein the upper chaffer is supported on an upper portion of said frame and the lower sieve is supported on a lower portion of said frame, wherein the diverter extends in a transverse direction between sides of the frame.

4. The cleaning system of claim 1 wherein the diverter is located near the front end of the chaffer.

5. The cleaning system of claim 4 wherein the diverter is located on the chaffer a distance from the front of the chaffer, wherein the distance is between 10% and 30% of the total length of the chaffer.

6. The cleaning system of claim 1 wherein the diverter has a horn shape with a narrow leading edge and a wider trailing edge with a concave air directing surface between the leading edge and trailing edge.

7. The cleaning system of claim 1 wherein the diverter oscillates with the chaffer.
